(19) United States
(12) Patent Application Publication
(10) Pub. No.: US 2022/0019731 A1
(43) Pub. Date: Jan. 20, 2022

(54) INFORMATION PROCESSING APPARATUS AND NON-TRANSITORY COMPUTER READABLE MEDIUM

(71) Applicant: FUJIFILM Business Innovation Corp., Tokyo (JP)

(72) Inventor: Yoshie MATSUO, Kanagawa (JP)

(73) Assignee: FUJIFILM Business Innovation Corp., Tokyo (JP)

(21) Appl. No.: 17/224,141

(22) Filed: Apr. 7, 2021

(30) Foreign Application Priority Data
Jul. 16, 2020 (JP) 2020-121918

(51) Int. Cl. G06F 40/174; G06K 9/00; G06K 9/62; G06F 3/0482

(52) U.S. Cl. CPC G06F 40/174; G06K 9/00456; G06F 3/0482; G06K 9/6267; G06K 9/6201

(57) ABSTRACT

An information processing apparatus includes a processor configured to display plural items in the order in which the items are to be processed, switch an item to be processed in accordance with a predetermined user operation, and output a process result that has been obtained before the user operation is performed in the case where the user operation is performed and an item that has been the item to be processed before the user operation is performed matches a predetermined output condition.

### CROSS-REFERENCE TO RELATED APPLICATIONS

This application is based on and claims priority under 35 USC 119 from Japanese Patent Application No. 2020-121918 filed Jul. 16, 2020.

### BACKGROUND

### (i) Technical Field

The present disclosure relates to an information processing apparatus and a non-transitory computer readable medium.

### (ii) Related Art

In a form confirmation/correction work, a user occasionally fills a plurality of forms collectively, causes the content of items input to the forms to be displayed on a screen, and corrects the content as necessary. The result of processing the items which have been confirmed and corrected as necessary is output in accordance with an instruction from the user after all the processes to be performed on the plurality of forms which have been filled collectively are finished, for example.

An example of such a technique is described in Japanese Unexamined Patent Application Publication No. 2000-347777.

### SUMMARY

Occasionally, a plurality of items are displayed in the order in which the items are to be processed, the item to be processed is switched in accordance with a predetermined user operation, and the result of processes that have been performed so far is output when an instruction to output the process result is received from the user. In this case, it is necessary for the user to repeatedly perform an operation to switch the item to be processed and an operation to output the process result, and it is troublesome for the user to perform such operations.

Aspects of non-limiting embodiments of the present disclosure relate to reducing the number of operations performed by a user before a process result is output in the case where a plurality of items are displayed in the order in which the items are to be processed and the item to be processed is switched in accordance with a predetermined user operation, compared to the case where an operation to switch the item to be processed and an operation to output the process result are different operations.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to display a plurality of items in an order in which the items are to be processed, switch an item to be processed in accordance with a predetermined user operation, and output a process result that has been obtained before the user operation is performed in a case where the user operation is performed and an item that has been the item to be processed before the user operation is performed matches a predetermined output condition.

### BRIEF DESCRIPTION OF THE DRAWINGS

An exemplary embodiment of the present disclosure will be described in detail based on the following figures, wherein:

FIG. 1 is a block diagram illustrating a form processing device according to the present exemplary embodiment;

FIG. 2 illustrates an example of the data configuration of form information stored in a form information storage section according to the present exemplary embodiment;

FIG. 3 illustrates an example of the data configuration of output condition information set in an output condition information storage section according to the present exemplary embodiment and an example of the setting content;

FIG. 4 illustrates an example of the data configuration of output destination information stored in an output destination information storage section according to the present exemplary embodiment;

FIG. 5 illustrates an example of display of a form confirmation/correction screen according to the present exemplary embodiment;

FIG. 6 is a flowchart illustrating a confirmation/correction process according to the present exemplary embodiment;

FIG. 7 illustrates an example of display of a confirming screen according to the present exemplary embodiment;

FIG. 8 illustrates an example of display of a confirmed screen according to the present exemplary embodiment;

FIG. 9 illustrates a display example of a confirmation screen prepared in the present exemplary embodiment;

FIG. 10 illustrates a different display example of the confirmation screen prepared in the present exemplary embodiment;

FIG. 11 illustrates an example of display of a change screen according to the present exemplary embodiment;

FIG. 12 illustrates an example of display of a message screen according to the present exemplary embodiment;

FIG. 13 illustrates a different display example of the confirmed screen according to the present exemplary embodiment; and

FIG. 14 illustrates a different display example of the message screen according to the present exemplary embodiment.

### DETAILED DESCRIPTION

An exemplary embodiment of the present disclosure will be described below with reference to the drawings.

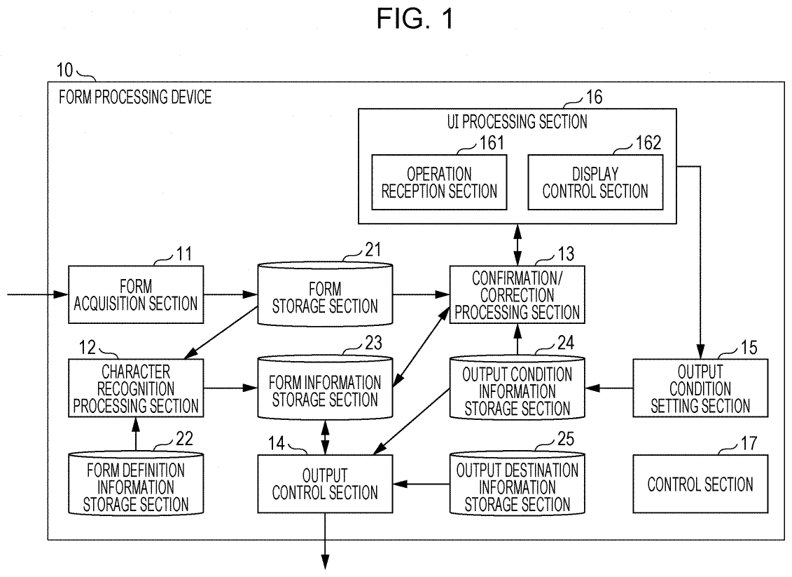

FIG. 1 is a block diagram illustrating a form processing device according to the present exemplary embodiment. A form processing device 10 according to the present exemplary embodiment corresponds to an exemplary embodiment of the information processing apparatus according to the present disclosure.

The form processing device 10 according to the present exemplary embodiment may be implemented by a general-purpose hardware configuration that has existed since previously such as a personal computer (PC). That is, the form processing device 10 includes a central processing unit (CPU), a storage unit such as a read only memory (ROM), a random access memory (RAM), and a hard disk drive (HDD), a mouse and a keyboard that are used as input units, a user interface including a display as a display unit, and a network interface (IF) as a communication unit.

In the present exemplary embodiment, as discussed in detail later, a plurality of items to be subjected to confirmation and correction processes are displayed as arranged on a screen, and the first item that has not been processed, among the plurality of items which are displayed in line on the screen, is presented to the user as an item to be processed. The item to be processed is switched in accordance with a predetermined user operation. In practice, the item to be processed is switched to an item arranged next to the present item to be processed. In the description of the present exemplary embodiment, a scroll operation is an example of the predetermined user operation.

The plurality of items to be processed in the present exemplary embodiment are written on a form. A form is an example of a document in which one or a plurality of items are written. In other words, the plurality of items to be processed are considered to be classified into a specific group, that is, a form. A form is occasionally constituted from a plurality of pages. In this case, the plurality of items are considered to be classified into a specific group, that is, a page that constitutes a form.

The form to be handled in the present exemplary embodiment is assumed to be one into which item values corresponding to various kinds of items such as person name, address, item name, quantity, and amount are to be hand-written. In the confirmation/correction work to be performed by the user, the item values which have been input to the form by handwriting are converted into electronic data using a character recognition process, and the user confirms through visual observation whether or not the result of the character recognition is correct. If any incorrect character recognition result is found, such a result is corrected to a correct character string. The form processing device 10 according to the present exemplary embodiment is used when the user performs the confirmation/correction work.

In the present exemplary embodiment, the user is caused to confirm the result of a character recognition process performed on the item values which have been input to the form by handwriting, and to correct the result if necessary. The action by the user to confirm the result of a character recognition process and correct the result as necessary is referred to as “confirmation/correction”. The confirmation/correction performed by the user when the user performs the confirmation/correction is referred to as a “confirmation/correction work”, the work performed by the user on individual items to be processed in the confirmation/correction work is referred to as “confirmation/correction”, and the confirmation/correction performed by the form processing device 10 when the user performs the confirmation/correction work is referred to as a “confirmation/correction process”. Since such actions are performed at the same time, the terms may not be used definitely differentially.

As illustrated in FIG. 1, the form processing device 10 according to the present exemplary embodiment includes a form acquisition section 11, a character recognition processing section 12, a confirmation/correction processing section 13, an output control section 14, an output condition setting section 15, a user interface (UI) processing section 16, and a control section 17. The form processing device 10 also includes, as storage units for various kinds of information, a form storage section 21, a form definition information storage section 22, a form information storage section 23, an output condition information storage section 24, and an output destination information storage section 25. Constituent elements that are not used to describe the present exemplary embodiment are not illustrated in the drawing.

The form acquisition section 11 acquires a form from an external computer such as a server that manages the form, for example. To be exact, the form acquisition section 11 acquires a read image generated when the form is read by a scanner etc. In the following description, for convenience of description, electronic form data that may be processed by a computer are also referred to simply as a “form”. The form acquisition section 11 saves a plurality of acquired forms in the form storage section 21.

The character recognition processing section 12 extracts item values to be subjected to the confirmation/correction process, from character strings written in the forms, by performing a character recognition process. The item values are represented as character strings. The “character string” is composed of one or a plurality of characters. Form definition information stored in the form definition information storage section 22 prescribes, for each kind of the forms, items on the form to be subjected to the confirmation/correction work and writing regions on the form for writing item values for such items. Thus, the character recognition processing section 12 extracts item values to be subjected to the confirmation/correction work with reference to the form definition information corresponding to the form to be processed. More particularly, the character recognition processing section 12 extracts pairs of a character image written in a writing region for an item value to be subjected to the confirmation/correction work and the result of a character recognition process performed on the character image, and saves such pairs in the form information storage section 23.

The confirmation/correction processing section 13 performs a confirmation/correction process in accordance with a user operation. The confirmation/correction process will be discussed in detail later. The output control section 14 controls output of the result of the confirmation/correction process in accordance with output condition information stored in the output condition information storage section 24. More specifically, when a scroll operation is performed and an item that has been the item to be processed before the scroll operation is performed matches a predetermined output condition, the output control section 14 collectively outputs a process result obtained before the scroll operation is performed (to be exact, a process result that has not been output). In the present exemplary embodiment, the result of the character recognition process is referred to simply as a “process result”. In the present exemplary embodiment, the process result is output as a file prepared in the Comma Separated Value (CSV) format. As a matter of course, this is exemplary, and the mode of output is not necessarily limited to the CSV format. The mode of output is also not limited to being output in a file format. The output condition setting section 15 sets an output condition in accordance with a user instruction. The setting content of the output condition is stored in the output condition information storage section 24 as the output condition information.

The user interface processing section 16 includes an operation reception section 161 and a display control section 162. The operation reception section 161 receives a user operation performed using the mouse, the keyboard, etc. The display control section 162 controls display on the display. The control section 17 controls operation of the constituent elements 11 to 16.

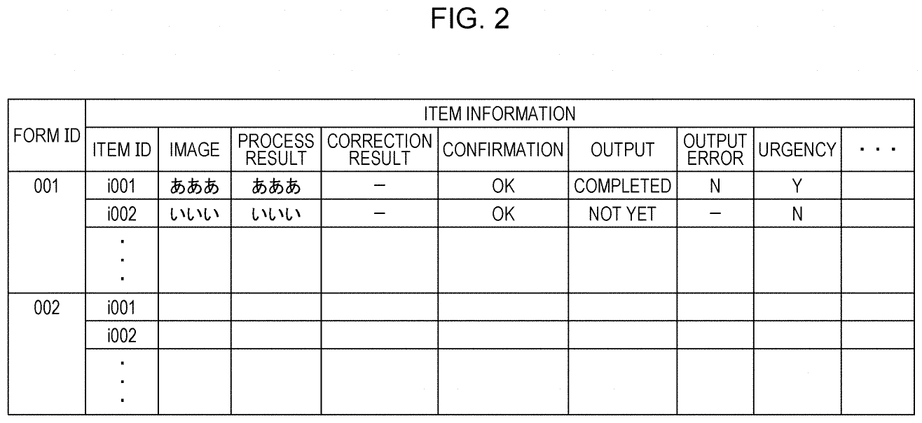

FIG. 2 illustrates an example of the data configuration of form information stored in the form information storage section 23 according to the present exemplary embodiment. Item information is correlated with the form information for each form. In FIG. 2, a form ID is identification information for identifying each form. Different identification information is set to even forms of the same kind. The form ID is information added to the forms acquired by the form acquisition section 11. The item information includes items such as item ID, image, process result, correction result, confirmation, output, output error, and urgency. The “item ID” is identification information for identifying each item. An image of an item value clipped from the form by the character recognition processing section 12 is set in the “image”. A character string obtained as a result of a character recognition process performed on the image is set in the “process result”. A character string obtained as a correction result in the case where the user has corrected the process result in the confirmation/correction work is set in the “correction result”. The “confirmation” is flag information that indicates whether or not the user has performed the confirmation/correction work during the confirmation/correction process. In the case where the confirmation/correction work has been performed, information indicating that the confirmation/correction work has been performed (a character string “OK” in the present exemplary embodiment) is set in the “confirmation”. The “output” is flag information that indicates whether or not the output control section 14 has output a process result for the item. “Completed” is set in the “output” in the case where a process result has already been output. “Not yet” is set in the “output” in the case where a process result has not been output yet. The “output error” is flag information that indicates the result of output by the output control section 14. The “output error” is set to “−” in the case where a process result was output normally, or in the case where a process result has not been output yet. The “output error” is set to “E” in the case where a process result was not output normally. The “urgency” is flag information that specifies an item desired to be urgently subjected to the confirmation/correction process, or in other words an item desired to be processed preferentially irrespective of the order of acquisition of forms or the order of arrangement (e.g. the order of writing) of items written on a form. The “urgency” is set to “Y” for an item desired to be processed preferentially, and set to “N” for the other items.

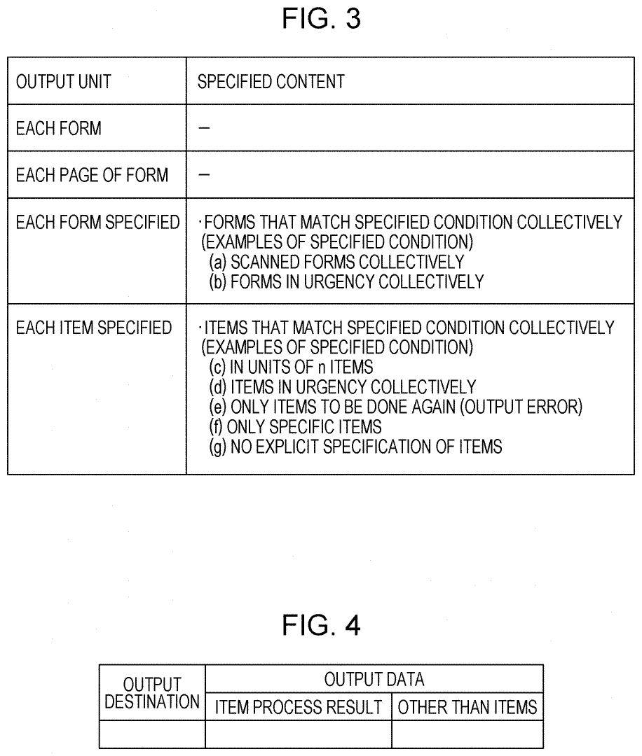

FIG. 3 illustrates an example of the data configuration of the output condition information set in the output condition information storage section 24 according to the present exemplary embodiment and an example of the setting content. An output condition set by the user is set in the output condition information. Specifically, the unit of output to the output destination is set, and conditions specified by the user are set in accordance with the output unit. In the present exemplary embodiment, “each form”, “each page of form”, “each form specified”, and “each item specified” may be set as the output condition. As a matter of course, the output condition may be set differently, depending on the type of the form or the document to be handled. In the case where “each form” is set, a CSV file is output when the confirmation/correction is finished for all the items included in a form. In the case where “each page of form” is set, a CSV file is output when the confirmation/correction is finished for all the items included in a page that constitutes a form. In the case where “each form specified” is set, a CSV file is output when the confirmation/correction is finished for all the items included in forms that match a condition set as an item in the specified content. In the case where “each item specified” is set, a CSV file is output when the confirmation/correction is finished for all the items that match a condition set as an item in the specified content.

FIG. 4 illustrates an example of the data configuration of output destination information stored in the output destination information storage section 25 according to the present exemplary embodiment. The configuration of data to be output to an output destination is set in the output destination information for each output destination of a CSV file. The configuration of the output data is set distinctively for “item process result” and “other than items”. An item, the process result of which is to be provided to the output destination, among items to be subjected to the confirmation/correction process, is set in the “item process result”. Information other than items to be subjected to the confirmation/correction process is set in the “other than items”. Examples of such information include a comment, remarks, etc. to be communicated to the output destination.

The constituent elements 11 to 17 of the form processing device 10 are implemented through cooperation between a computer that forms the form processing device 10 and a program that operates on a CPU integrated in the computer. The storage sections 21 to 25 are implemented by an HDD integrated in the form processing device 10. Alternatively, a RAM or an external storage unit may be used by way of a network.

The program used in the present exemplary embodiment may be not only provided by a communication unit but also provided as stored in a computer-readable storage medium such as a CD-ROM and a USB memory. The program provided from the communication unit or the storage medium is installed on the computer, and sequentially executed by the CPU of the computer to achieve various processes.

Next, the form confirmation/correction work performed by the user will be described.

First, in order to perform the confirmation/correction work, it is necessary for the user to take a form to be processed into the form processing device 10. To that end, the user selects a form to be processed from a database of forms held by a form management server, for example. The form acquisition section 11 acquires a plurality of forms selected by the user in accordance with an instruction from the user as forms to be subjected to the confirmation/correction work, and saves such forms in the form storage section 21. Here, for convenience of description, it is assumed that all the acquired forms are forms of the same kind, and that item values for the same items are acquired from the forms. The forms acquired by the form processing device 10 may be forms selected by the form management server and provided to the form processing device 10, rather than forms selected through a user operation.

When forms are acquired, the character recognition processing section 12 clips images of item values from the forms with reference to the form definition information, and performs a character recognition process on the clipped images. The character recognition processing section 12 correlates the item ID of the item which has been subjected to the character recognition process, the clipped image, and the process result of the character recognition process with the form ID of the form to be processed, and registers such information in the form information storage section 23. At this time, data are set in form ID, item ID, image, and process result in the form information, and a default value is set in the other items. However, information specified by the form management server or the user may be set in items other than “confirmation”, “output”, and “output error” which are set during execution of the confirmation/correction process. For example, the “urgency” flag information may be set at the time of acquisition of forms for items desired to be processed urgently.

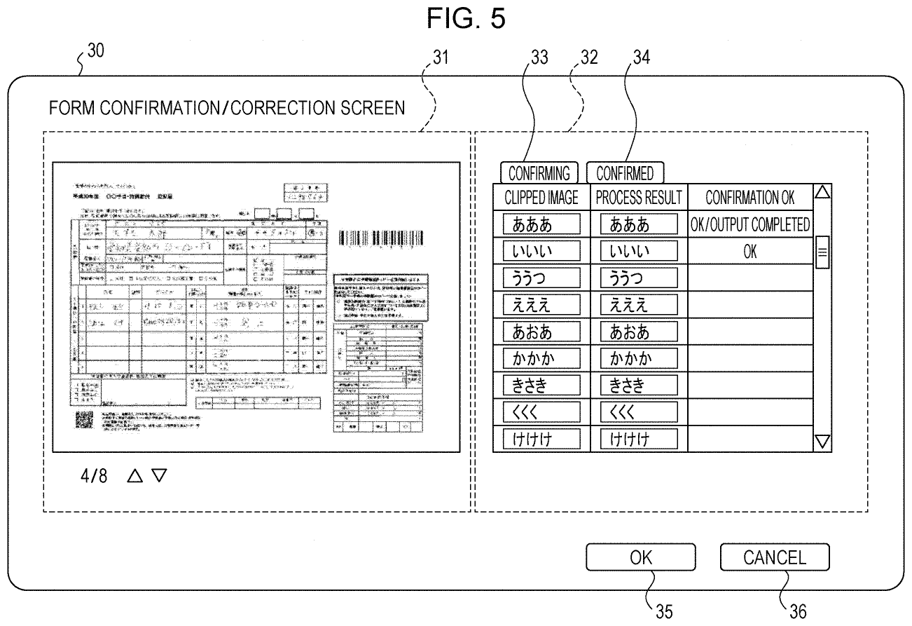

The confirmation/correction work is performed using a confirmation/correction screen. An example of display of a form confirmation/correction screen according to the present exemplary embodiment is illustrated in FIG. 5.

A form display region 31 for displaying an image of a form acquired by the form acquisition section 11 and a confirmation/correction region 32 for the user to perform the confirmation/correction are displayed on a form confirmation/correction screen 30. Characters hand-written in the form are subjected to a character recognition process. Clipped images of the hand-written characters and the result of the character recognition process on the hand-written characters are displayed side by side in the confirmation/correction region 32 as items to be confirmed. The user confirms the content of handwritten input to the form with reference to the confirmation/correction region 32. Two tabs 33 and 34, namely “confirming” and “confirmed” tabs, are displayed on a screen (hereinafter referred to as a “confirmation/correction process screen”) displayed in the confirmation/correction region 32. A confirming screen is displayed in the confirmation/correction region 32 when the confirming tab 33 is selected by the user. A confirmed screen is displayed in the confirmation/correction region 32 when the confirmed tab 34 is selected by the user.

The hand-written characters and the process result for the hand-written characters are collated with each other on the confirming screen to confirm whether or not the process result matches the hand-written characters. If the character recognition result does not match the hand-written characters, the user corrects the process result. The user performs the confirmation/correction for each item as described above. Items, for which the confirmation/correction has been finished, are displayed on the confirmed screen. Items, for which the confirmation/correction has been finished, may also be kept displayed on the confirming screen. In the following description, the confirming screen and the confirmed screen will be collectively referred to as a “confirmation/correction process screen” when no distinction is made between such screens. A pair of a clipped image and a process result corresponding to each item is displayed on the confirmation/correction process screen. In the description made using the confirmation/correction process screen, a pair of a clipped image and a process result corresponding to an item will also be conveniently referred to as an “item”. The confirmation/correction process screen will be discussed in detail later.

When all the items included in all the forms to be processed are processed, the user selects an OK button 35 to finish the confirmation/correction work. In the case where a cancel button 36 is selected, the form processing device 10 determines that the confirmation/correction process has been suspended, and finishes the confirmation/correction process.

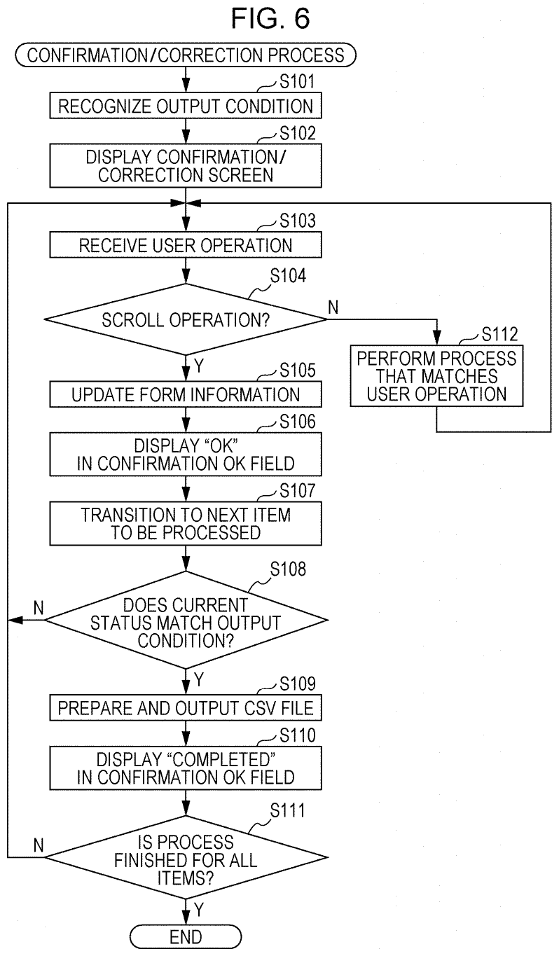

The confirmation/correction process in which the user confirms and corrects the process result on the screen displayed in the confirmation/correction region 32 of the form confirmation/correction screen 30 will be described below with reference to the flowchart illustrated in FIG. 6.

When the form acquisition section 11 acquires a plurality of forms to be processed in accordance with a user operation and the character recognition processing section 12 extracts a clipped image and a process result of an item value to be processed from each form as discussed earlier, the confirmation/correction processing section 13 is activated by the control section 17 to start the confirmation/correction process.

The confirmation/correction processing section 13 first recognizes an output condition by reading set output condition information from the output condition information storage section 24 (step 101). The confirmation/correction processing section 13 displays a form confirmation/correction screen 30 (step 102). At this time, the confirmation/correction processing section 13 determines the order of arrangement of items (i.e. pairs of a clipped image and a process result) to be displayed on the confirmation/correction process screen in accordance with the output condition.

For example, it is assumed that the form acquisition section 11 has acquired forms 1 to m (m is a natural number of two or more). When the order of arrangement of items is determined, each form may be composed of one or a plurality of pages. It is also assumed that “each form” or “each page of form” is set as the output unit in the output condition. In this case, the confirmation/correction processing section 13 sequentially arranges all the n (n is a natural number) items included in the form 1. Subsequent to the items in the form 1, all the items included in the form 2 are arranged sequentially. Further, all the items included in the forms 3 to m are similarly arranged sequentially subsequent to the items in the preceding form.

In the case where “each form specified” is set as the output unit in the output condition, the items are arranged such that the items included in a specified one of the forms 1 to m are arranged preferentially, i.e., first. For example, in the case where “(b) Forms in urgency collectively” indicated in FIG. 3 is specified as the output condition, forms including an item, for which the “urgency” flag is set, are arranged preferentially, or first, with reference to the form information.

Meanwhile, it is assumed that “each item specified” is set as the output unit in the output condition. In this case, the confirmation/correction processing section 13 arranges the specified items preferentially, i.e., first. For example, in the case where each form includes items “name”, “number ordered”, and “amount payable” and the specified content in the output condition specifies “number ordered” (this corresponds to the specified content (f) in FIG. 3), the confirmation/correction processing section 13 arranges “number ordered” in the form 1, “number ordered” in the form 2, . . . , and “number ordered” in the form m, which are followed by “name” in the form 1, “name” in the form 2, . . . , and “name” in the form m. Such items are further followed by “amount payable” in each of forms 1 to m.

In the case where the specified content in the output condition does not specify any item (this corresponds to the specified content (g) in FIG. 3), the confirmation/correction processing section 13 sets the order of arrangement of items in accordance with the arrangement of items in each form. That is, “name” in the form 1, “name” in the form 2, . . . , and “name” in the form m are arranged, which are followed by “number ordered” in the form 1, “number ordered” in the form 2, . . . , and “number ordered” in the form m, which are further followed by “amount payable” in each of the forms 1 to m.

The confirmation/correction processing section 13 determines the order of arrangement of items to be displayed on the confirmation/correction process screen in accordance with the output condition as described above. While the confirmation/correction processing section 13 causes the display control section 162 to display each screen such as the confirmation/correction process screen, the expression “the confirmation/correction processing section 13 displays such a screen” is occasionally used in the following description for convenience.

FIG. 7 illustrates an example of display of a confirming screen to be displayed in the confirmation/correction region 32 on the form confirmation/correction screen 30 according to the present exemplary embodiment. The confirming screen is displayed when the confirming tab 33 is selected on the screen displayed in the confirmation/correction region 32 as discussed earlier.

In the confirming screen, items, that is, pairs of a clipped image and a process result of item values of such items, are displayed in the order of arrangement determined as described above. A “Confirmation OK” field is provided in correspondence with each item.

The user processes the items sequentially from the top of the confirming screen. In other words, the confirmation/correction processing section 13 specifies items to be processed such that unprocessed items are processed sequentially from the top. The user collates a clipped image and a process result on the confirming screen, and confirms whether or not the process result is correct. In the case where any error is found in the process result, the character string displayed in the “Process result” field is corrected to a correct character string with reference to the clipped image. In the case where it is determined that the process result is correct, no correction is made.

When the user confirms, and corrects as necessary, the item to be processed, a transition is made to the next item to be processed. In the present exemplary embodiment, the user performs a scroll operation to transition to the next item to be processed. When the user performs any operation, the operation reception section 161 receives the operation (step 103). In the case where the operation is not a scroll operation (N in step 104), such a case will be discussed later. In the case where the operation is a scroll operation (Y in step 104), the confirmation/correction processing section 13 updates form information on the item for which the confirmation/correction process has been finished (step 105). That is, “OK” which indicates that the item has been confirmed is set to “Confirmation” in the form information. In the case where the process result is corrected, the content of the correction is set in the “correction result”. Further, the confirmation/correction processing section 13 displays “OK”, which indicates that the confirmation/correction has been finished, in the confirmation OK field corresponding to the item, for which the confirmation/correction has been finished, on the confirming screen (step 106).

In the display example of the confirming screen illustrated in FIG. 7, when a process for the second item from the top is finished, “OK” 37 is displayed in the corresponding confirmation OK field to allow the user to confirm that the process has been finished. The confirmation/correction processing section 13 transitions to the next item to be processed (step 107). The confirmation/correction processing section 13 allows the user to recognize the item to be processed, by displaying a display correction field 38 in the “process result” field for the next item as the transition destination (the third item in the display example of the confirming screen illustrated in FIG. 7) using a thick frame. While the item to be processed is indicated using a thick frame in the present exemplary embodiment, the present disclosure is not limited thereto. For example, a different display attribute may be controlled, such as by making the background color of a row for the item to be processed different from the background color for items that are not the item to be processed. The user basically performs the confirmation/correction for all the items included in all the forms to be processed, by repeatedly executing the confirmation/correction and the scroll operation discussed earlier.

The output control section 14 monitors the confirmation/correction work performed by the user at all times. The output control section 14 confirms whether or not the present status of the confirmation/correction matches the output condition each time the user performs the confirmation/correction for an item. For example, in the case where “each form” is set in the output condition, it is confirmed whether or not the confirmation/correction has been finished for all the items included in a form through the scroll operation. In the case where the confirmation/correction has not been finished (N in step 108), the process proceeds to step 103.

In the case where the confirmation/correction has been finished for a form (Y in step 108), the output control section 14 automatically prepares a CSV file in accordance with the setting content in the form information, and automatically outputs the prepared CSV file (step 109).

That is, in the present exemplary embodiment, it is not necessary to cause the user to perform an operation to prepare and output a CSV file. It is only necessary that the user should perform the confirmation/correction for each item displayed and perform a scroll operation in order to switch to the next item to be processed, only if the output condition is set in advance.

In the description, the output control section 14 confirms whether or not the present status of the confirmation/correction matches the output condition. However, the confirmation/correction processing section 13 may perform the confirmation and instruct the output control section 14 to output a CSV file. Alternatively, the control section 17 may perform a process to collate the present status of the confirmation/correction and the output condition.

In the case where “each form” is set in the output condition, the output control section 14 prepares a CSV file by reading the content of a process performed on a form, for which the confirmation/correction has been finished, from form information. The output control section 14 outputs the prepared CSV file to a predetermined output destination. Here, the CSV file is output to only one output destination. Output to a plurality of output destinations will be discussed later.

When output to the output destination is finished, the confirmation/correction processing section 13 sets “completed”, which indicates that output is completed, in the “output” in the form information, and displays “Output completed”, which indicates that output has been finished, in the confirmation OK field corresponding to the item, for which output has been finished, on the confirming screen (step 110).

If the confirmation/correction process has been finished for all the items included in all the forms to be processed (Y in step 111), the confirmation/correction process is ended. If not (N in step 111), the process proceeds to step 103.

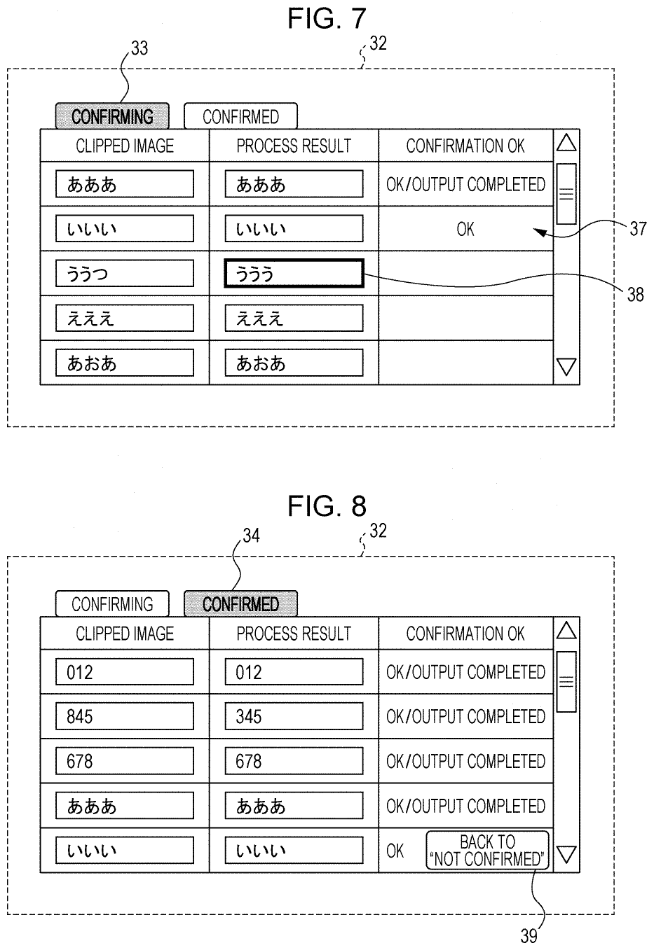

FIG. 8 illustrates an example of display of a confirmed screen to be displayed in the confirmation/correction region 32 on the form confirmation/correction screen 30 according to the present exemplary embodiment. The confirmed screen is displayed when the confirmed tab 34 is selected on the confirmation/correction process screen as discussed earlier.

The confirming screen and the confirmed screen may be of the same type. However, while all the items to be processed are displayed on the confirming screen, items, for which the confirmation/correction has been finished, are extracted from all the items to be processed on the confirming screen, and displayed on the confirmed screen. Thus, some display is made in the “confirmation OK” field for each item on the confirmed screen. When the confirmed tab 34 is selected by the user, the confirmation/correction processing section 13 extracts items, for which “OK” is set in the “confirmation” field, with reference to the form information, and displays such items on the confirmed screen. “OK” is displayed in the “confirmation OK” field on the confirmed screen. Further, the confirmation/correction processing section 13 displays “output completed” in the “confirmation” field for items, for which output has been finished, among the extracted items, with reference to “output completed” in the form information.

The user occasionally finds, in the confirmed screen, a wrong process result due to oversight, erroneous correction, etc. caused in the confirmation/correction performed on the confirming screen. In this case, a “back to not confirmed” button 39 is displayed in correspondence with an item, for which output has not been finished, in order to perform the confirmation/correction again. The “back to not confirmed” button 39 may be displayed also for an item, for which output has been finished, in order to perform the confirmation/correction and output again.

When the user selects the “back to not confirmed” button 39, the confirmation/correction processing section 13 deletes “OK” from the “confirmation” field for the corresponding item in the form information, and deletes such an item from the confirmed screen. Consequently, in the case where the confirming tab 33 is selected and the confirming screen is displayed, “OK” is also deleted from the “confirmation OK” field for the item.

In the example described above, “each form” is set as the output condition. In the case where “each page of form” is set as the output condition, for example, the output control section 14 prepares and outputs a CSV file containing the process result of the confirmation/correction for all the items included in a page that constitutes a form each time the confirmation/correction is finished for all the items included in such a page.

In the case where “each form specified” is set as the output condition, the output control section 14 prepares and outputs a CSV file containing the process result of the confirmation/correction for all the items included in all the forms specified as the specified content in the output condition when the confirmation/correction is finished for all such items.

In the case where “each item specified” is set as the output condition, the output control section 14 prepares and outputs a CSV file containing the process result of the confirmation/correction for all the items specified as the specified content in the output condition when the confirmation/correction is finished for all such items. For example, in the case where each form includes items “name”, “number ordered”, and “amount payable” and the specified content in the output condition specifies “number ordered” as a specific item (this corresponds to the specified content (f) in FIG. 3) as indicated above, the confirmation/correction processing section 13 displays the items on the confirming screen in the order of “number ordered” in the form 1, “number ordered” in the form 2, . . . , “number ordered” in the form m, “name” in the form 1, “name” in the form 2, . . . , “name” in the form m, “amount payable” in the form 1, “amount payable” in the form 2, . . . , and “amount payable” in the form m, and causes the user to perform the confirmation/correction in this order of arrangement. When the confirmation/correction for “number ordered” in the form m is finished and a scroll operation is performed to switch to the next item to be processed, that is, “name” in the above example, the output control section 14 prepares and outputs a CSV file containing the result of processes that have been performed so far, that is, the process result for items “number ordered” in the forms 1 to m. Subsequently, when the confirmation/correction for “name” in the form m is finished and a scroll operation is performed to switch to the next item to be processed, that is, “amount payable” in the above example, the output control section 14 prepares and outputs a CSV file containing the result of processes that have been performed so far, or a process result that has not been output yet, among the result of processes that have been performed so far, to be exact, that is, the process result for items “name” in the forms 1 to m. Similarly, upon recognizing that the confirmation/correction has been finished for “amount payable” in the form m, the output control section 14 prepares and outputs a CSV file containing the process result for items “amount payable” in the forms 1 to m.

A basic confirmation/correction process has been described above. In the present exemplary embodiment, additional functions are further prepared. The additional functions will be described below. Examples of a user operation other than a scroll operation (N in step 104) include operations to be performed on a screen displayed through the additional functions to be described below.

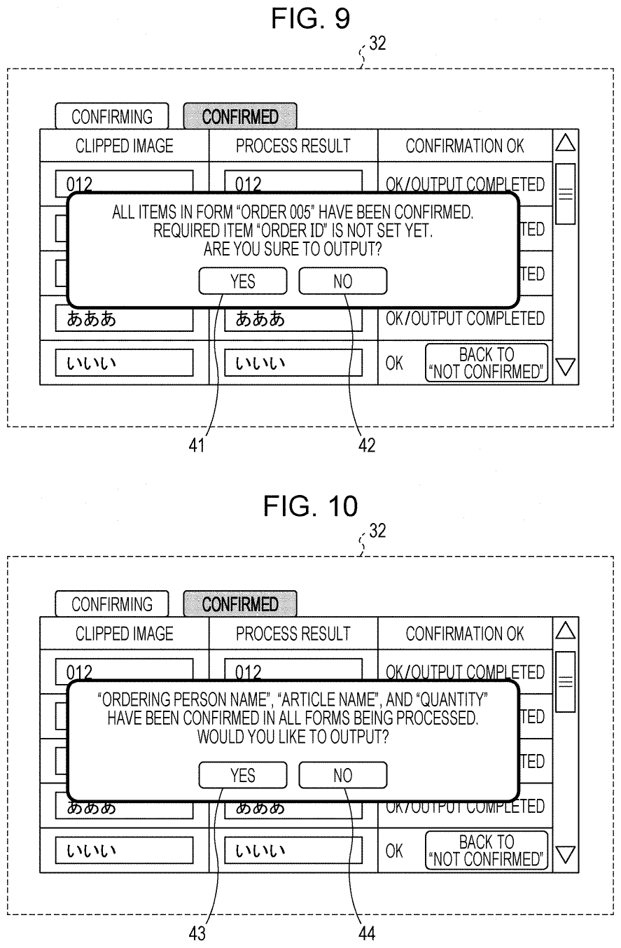

FIG. 9 illustrates a display example of the confirmation screen prepared in the present exemplary embodiment. FIG. 9 illustrates a display example of a confirmation screen for the confirmation/correction processing section 13 or the output control section 14 to inquire the user whether or not to output a CSV file when it is attempted to prepare a CSV file as the confirmation/correction is finished for all the items included in a form (“order 005” in the example illustrated in FIG. 9) in the case where “each form” is set as the output condition but the process result for an item included in the form (“order ID” in the example illustrated in FIG. 9, which is required to be filled with a process result and not permitted to be blank) is blank. The user references the confirmation screen, and selects a “yes” button 41 in the case where it is desired to output a CSV file even if the required item is blank. Consequently, the output control section 14 prepares and outputs a CSV file corresponding to the form (“order 005” in the example illustrated in FIG. 9). If the user selects a “no” button 42, on the other hand, the confirmation/correction processing section 13 displays the item (“order ID” in the example illustrated in FIG. 9) included in the form (“order 005” in the example illustrated in FIG. 9) at least on the confirming screen, and causes the user to perform the confirmation/correction again.

FIG. 10 illustrates a different display example of the confirmation screen prepared in the present exemplary embodiment. While a CSV file is automatically output in the case where output may be made using the output unit which matches the output condition in the above description, the user may be inquired whether or not to output a CSV file, by displaying the confirmation screen illustrated in FIG. 10, each time output may be made, rather than automatically outputting a CSV file. In the example in FIG. 10, “each item specified” is set as the output condition, and the specified content is set such that “ordering person name”, “article name”, and “quantity” are to be output collectively. When the user selects a “yes” button 43, the output control section 14 prepares and outputs a CSV file containing the process result for “ordering person name”, “article name”, and “quantity” in all the forms. When the user selects a “no” button 44, on the other hand, the output control section 14 does not output a CSV file. In this case, the confirmation/correction processing section 13 may display a change screen for changing the output condition on the screen.

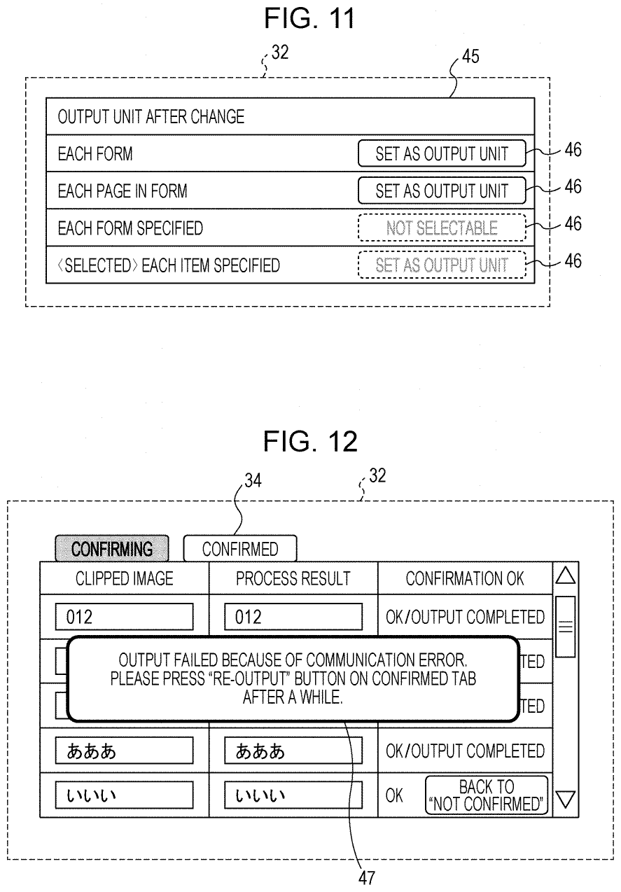

FIG. 11 illustrates an example of display of the change screen according to the present exemplary embodiment. A change screen 45 displays a list of output units in an output condition. The change screen 45 illustrated in FIG. 11 corresponds to the output units indicated in FIG. 3. A select button 46 is displayed in correlation with each of the output units displayed on the change screen 45. The select button 46 is displayed in different forms in accordance with whether or not the output unit is selectable. For example, the select button 46 corresponding to a selectable output unit is indicated with a solid frame to indicate that the output unit is selectable. On the other hand, the select button 46 corresponding to an unselectable output unit is indicated with a dashed frame and a thin font color to indicate that the output unit is unselectable. When an output unit is selected on the change screen 45, the confirmation/correction processing section 13 updates the output condition information using the selected output unit.

FIG. 12 illustrates a display example of a message screen displayed when an output error is caused in the present exemplary embodiment. As discussed earlier, it is determined whether or not an item matches an output condition at the timing when the item is processed and a transition is made to the next item to be processed, and in the case where the item matches the output condition, the output control section 14 automatically outputs a CSV file containing a process result for an item that has not been output yet, even if there is no instruction operation from the user or even while the user is performing the confirmation/correction. That is, while a CSV file is output in the background of the confirmation/correction work, there may be a case where the CSV file may not be normally delivered to the output destination because of the occurrence of any failure such as a communication error.

Thus, in the case where a communication error etc. is caused, the output control section 14 according to the present exemplary embodiment displays a message screen 47 to notify the user of a failure in outputting a CSV file. The output control section 14 manages information that a CSV file has not been output by setting “E” in the “output error” field included in the form information in correspondence with the item, for which a CSV file was not output.

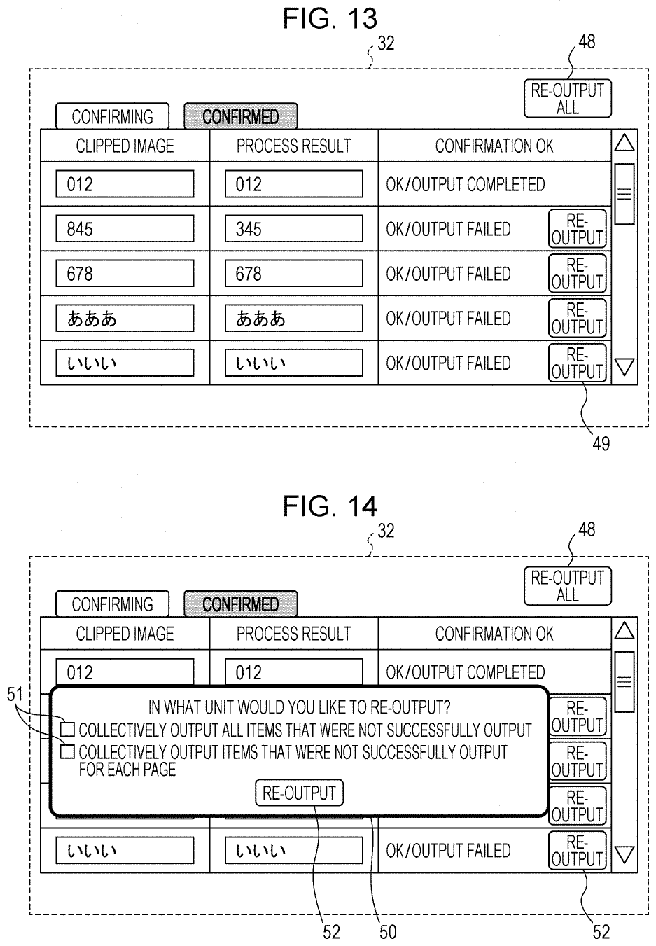

When it is desired to re-output the process result for an item, for which transmission failed, in accordance with the displayed message, the user selects the confirmed tab 34 to display a confirmed screen. FIG. 13 illustrates the confirmed screen displayed at this time. In the case where an error is caused, as illustrated in FIG. 13, the confirmation/correction processing section 13 displays a “re-output all” button 48 and a “re-output” button 49 in correspondence with each of items, for which a CSV file was not output, on the confirmed screen.

In the case where it is desired to re-output an item individually, the user selects the “re-output” button 49 corresponding to the item desired to be output. The output control section 14 outputs the selected item in accordance with this user operation. In the case where it is desired to re-output a plurality of items collectively, the user selects the “re-output all” button 48. The confirmation/correction processing section 13 displays a message screen in accordance with this operation. A display example at the time when the message screen is displayed is illustrated in FIG. 14.

The user is allowed to select a unit for re-output on a message screen 50. In the display example illustrated in FIG. 14, the user is allowed to select whether to collectively output all the items, for which output failed, or to output all the items, for which output failed, page by page. As a matter of course, this is an example of the output unit, and a different output unit may also be selected. When the user selects a “re-output” button 52 after ticking any of check boxes 51 corresponding to the desired output unit, the output control section 14 extracts items corresponding to the output unit selected by the user from among the items, for which output failed, and outputs such items. In the case where re-output to the output destination is finished normally, the output control section 14 changes the “output error” field included in the form information to “−”.

In the above description, a CSV file is output to only one output destination for convenience. A case where a CSV file is output to a plurality of output destinations will be discussed in detail.

In the output destination information, as indicated in FIG. 4, the type of data to be output to an output destination is set for each output destination. Thus, the output control section 14 controls output of a CSV file in accordance with the content set in the output destination information. In the case where “each form” is set as the output unit, for example, the output control section 14 prepares and outputs a CSV file corresponding to each output destination when the confirmation/correction is finished for all the items included in a form. At this time, the output control section 14 extracts, as items to be output, only items set for “item process result” in the output data corresponding to the output destination in the output destination information, and prepares a CSV file. This allows each output destination to obtain only a process result to be required in a later process to be performed at the output destination. That is, it is not necessary that all the items included in a form should be output.

The output control section 14 also outputs information set in “other than items” in the output data in the output destination information together with the CSV file. If the information set in “other than items” may be included in the CSV file, such information may be output as included in the CSV file in consultation with the output destination.

In this manner, in step 109 in the flowchart illustrated in FIG. 6, the output control section 14 references the output destination information, extracts items specified in “item process result” from among all the items included in the output unit, and prepares and outputs a CSV file for each output destination.

In the present exemplary embodiment, as described above, a transition is made to the next item to be processed in accordance with a scroll operation by the user, and a CSV file is automatically prepared and output for each output unit if a process for items included in an output unit set in the output condition is finished at the timing when a transition is made to the item to be processed. That is, the user is not required to perform an operation to output a CSV file.

In the present exemplary embodiment, a scroll operation is described as an example of a predetermined user operation to transition to the next item to be processed. The scroll operation may be performed by operating a wheel of a mouse etc., for example. Some mice are provided with a function to vary the amount of scroll in accordance with the amount or speed of rotation of the wheel, depending on the wheel setting. In the present exemplary embodiment, however, when the user performs a scroll operation, a transition is made on the confirmation/correction process screen from the present item to be processed to the next item, irrespective of the amount of the scroll operation.

Scroll may be performed in the direction opposite to the forward direction in which the item to be processed is switched to the next item. Scroll in the opposite direction may be prohibited while the confirmation/correction work is performed on the confirmation/correction process screen. Alternatively, the item to be processed may be returned to a confirmed item to be overwritten. In this case, it is necessary to resolve the confirmed state of the item selected as the item to be processed through scroll in the opposite direction. Specifically, “OK” is deleted from “confirmation” in the item information in the form information, and “OK” is deleted from the “confirmation OK” field on the confirming screen.

In the present exemplary embodiment, the confirmation/correction process is performed on a form which is an example of a document. This is exemplary, and the process to be performed is not necessarily limited to the confirmation/correction process. In the description, the items to be processed are classified into a specific group such as a form or a page that constitutes a form. However, such items may not be classified into a specific group.

In the embodiment above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiment above, the term “processor” is broad enough to encompass one processor or plural processors in collaboration which are located physically apart from each other but may work cooperatively. The order of operations of the processor is not limited to one described in the embodiment above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising a processor configured to
display a plurality of items in an order in which the items are to be processed,
switch an item to be processed in accordance with a predetermined user operation, and
output a process result that has been obtained before the user operation is performed in a case where the user operation is performed and an item that has been the item to be processed before the user operation is performed matches a predetermined output condition.

2. The information processing apparatus according to claim 1,
wherein the processor is configured to set the output condition in accordance with a user instruction.

3. The information processing apparatus according to claim 1,
wherein the plurality of items are classified into a specific group,
the output condition prescribes that output should be made for each specific group, and
the processor is configured to output the process result for the item which matches the output condition at a time when a process has been finished for all the items included in the specific group.

4. The information processing apparatus according to claim 2,
wherein the plurality of items are classified into a specific group,
the output condition prescribes that output should be made for each specific group, and
the processor is configured to output the process result for the item which matches the output condition at a time when a process has been finished for all the items included in the specific group.

5. The information processing apparatus according to claim 3,
wherein the specific group is a document or a page that constitutes a document.

6. The information processing apparatus according to claim 4,
wherein the specific group is a document or a page that constitutes a document.

7. The information processing apparatus according to claim 1,
wherein the output condition prescribes that output should be made for a specific item, and
the processor is configured to output the process result which has been obtained before the user operation is performed in a case where the item to be processed is switched from the specific item to a different item through the user operation and a process has been completed for the specific item.

8. The information processing apparatus according to claim 2,
wherein the output condition prescribes that output should be made for a specific item, and
the processor is configured to output the process result which has been obtained before the user operation is performed in a case where the item to be processed is switched from the specific item to a different item through the user operation and a process has been completed for the specific item.

9. The information processing apparatus according to claim 1,
wherein the processor is configured to inquire a user whether or not to output the process result, before outputting the process result.

10. The information processing apparatus according to claim 9,
wherein the processor is configured to make setting of the output condition changeable in a case where the user selects not to output the process result.

11. The information processing apparatus according to claim 1,
wherein the processor is configured to notify a user that the process result was not output normally in a case where the process result was not output normally.

12. The information processing apparatus according to claim 11,
wherein the processor is configured to re-output the process result for the item, for which the process result was not output normally, in a unit specified by the user.

13. The information processing apparatus according to claim 12,
wherein the unit specified by the user is all the process result for the item, for which the process result was not output normally, or item by item.

14. The information processing apparatus according to claim 1,
wherein the processor is configured to output, in a case where an output destination of an item process result has been determined for each item or a plurality of items, the item process result to the output destination determined in advance for each item or a plurality of items when the user operation is performed.

15. A non-transitory computer readable medium storing a program causing a computer to execute a process comprising:
displaying a plurality of items in an order in which the items are to be processed;
switching an item to be processed in accordance with a predetermined user operation; and
outputting a process result that has been obtained before the user operation is performed in a case where the user operation is performed and an item that has been the item to be processed before the user operation is performed matches a predetermined output condition.

16. An information processing apparatus comprising
means for displaying a plurality of items in an order in which the items are to be processed,
means for switching an item to be processed in accordance with a predetermined user operation, and
means for outputting a process result that has been obtained before the user operation is performed in a case where the user operation is performed and an item that has been the item to be processed before the user operation is performed matches a predetermined output condition.
